(19) United States
(12) Patent Application Publication
(10) Pub. No.: US 2004/0088903 A1
(43) Pub. Date: May 13, 2004

(54) Subterranean bait station

(76) Inventor: Richard M. Poche, Wellington, CO (US)

Correspondence Address: Dean P. Edmundson, P.O. Box 179, Burton, TX, 77835, US

(21) Appl. No.: 10/694,159

(22) Filed: Oct. 27, 2003

Related U.S. Application Data
(60) Provisional application No. 60/424,876, filed on Nov. 12, 2002.

(51) Int. Cl. A01M 23/02; A01M 23/16; A01M 23/32

(52) U.S. Cl. 43/61

(57) ABSTRACT

A bait station and method for introducing a bait composition to vertebrate pests which inhabit underground burrows or tunnels. The bait station includes a housing with one or more openings in the side walls for the pests to enter and feed on the bait composition. A vertical tube can be used to add bait composition to the station through an aperture in the top surface of the station.

### CROSS-REFERENCE TO RELATED APPLICATION

This application is based upon, and claims the benefit of, my Provisional Application No. 60/424,876, filed Nov. 12, 2002.

### FIELD OF THE INVENTION

This invention relates to control of burrowing rodents, moles, shrews, and other subterranean pests. More particularly, it relates to bait stations for such pests, and the positioning of such bait stations.

### BACKGROUND OF THE INVENTION

Bait stations are used as a receptacle for presenting baits for the control of vertebrate pests such as rodents, ants, moles, shrews, etc. Current designs of bait stations require that they be used above ground for primarily rats and mice in homes or businesses. Such bait stations are not very effective, however, for burrowing rodents, moles, shrews, etc.

### SUMMARY OF THE INVENTION

In accordance with the invention there is provided a subterranean bait station and method for presenting bait to burrowing rodents and insectivores and insects. The bait station includes one or more openings for the burrowing pests to enter the bait station. Preferably the bait station also includes an opening in its upper surface through which bait composition can be added to the bait station.

The bait station is preferably positioned in the ground such that the opening(s) in the bait station is in or accessible from tunnels in the ground. Thus, the mammals or pests which inhabit or frequent the tunnels can access the bait composition in the bait station.

Other features and advantages of the bait station and method of the invention will be apparent from the following detailed description and accompanying drawings.

### BRIEF DESCRIPTION OF THE DRAWINGS

The invention is described in more detail hereinafter with reference to the accompanying drawings.

FIG. 1 is a side elevational view illustrating a preferred bait station of the invention in the ground;

FIG. 2 is another side elevational view of the bait station of FIG. 1; and

FIG. 3 is a top plan view of the bait station of FIG. 1.

### DETAILED DESCRIPTION OF THE INVENTION

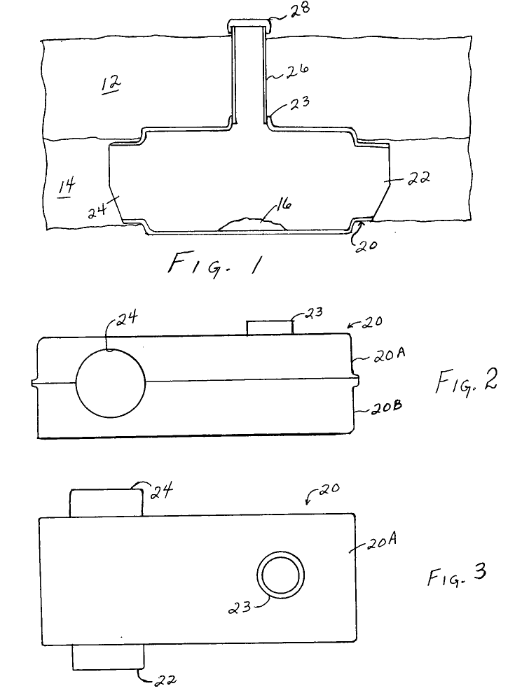

In FIG. 1 there is illustrated one embodiment of the bait station system 20 of the present invention positioned under ground 12 such that the two openings 22 and 24 in opposite side walls of the bait station are aligned with the longitudinal axis of the existing rodent tunnel 14. A bait composition 16 can be poured into the bait station through vertical tube 26 attached to opening 23 in the upper surface of the bait station 20. A cap 28 can be placed over the top end of the tube 26 after the bait composition has been inserted.

Although the bait station can be placed under ground and in alignment with an existing burrow or tunnel, it is also possible to place the bait station in alignment with an artificial burrow or tunnel that may be constructed with a mechanical burrow builder. Bait that is placed into the bait station is protected from the weather, children, pets, and wildlife that does not use the burrow or tunnel. This system does not require the animal to move above ground to consume bait, thus making the bait available within the constant environment of its underground habitat. The system is useful for presenting bait to a variety of subterranean animals such as rodents, pocket gophers, moles, voles, shrews, mountain beavers, ground squirrels, marmots, insectivores and insects (e.g. ants).

The bait station can be composed of any suitable material such as plastic (e.g. PVC), wood, metal, or composite materials. Preferably the bait station 20 includes two openings 22 and 24 in opposing side walls which can be aligned with the longitudinal axis of the tunnel 14. This enables rodents, etc. to enter the bait station from either end of the tunnel. An opening 23 in the top surface of the bait station enables a vertical tube 26 to be attached to the bait station for adding bait composition to the bait station, as required, without removing the bait station from the tunnel. If desired, the bait station may comprise mating housing portions 20A and 20B which are separately molded but are fitted together to form the housing. Above each opening 22 and 24 is an extension of the wall of the station in the form of an eave which inhibits dirt from falling into the bait station once it is placed underground. Preferably the bottom of the openings 22 and 24 are at the same level as the bottom of the tunnels.

The size and shape of the bait station may vary. For mouse-sized animals, the bait station may be about 6 inches by 6 inches by 3 inches high, with side openings of about one inch in diameter. For rat-sized animals, the size may be 12 inches by 12 inches by 5 inches high, with side openings of about 3 inches. For pocket gophers, etc. the size may be about 8 inches long by 5 inches wide by 4 inches high. The opening 23 and tube 26 may be about 2 to 4 inches in diameter.

A variety of bait compositions may be used containing different active ingredients, e.g. warfarin, chlorophacinone, diphacinone, bromadiolone, brodifacoum, difethialone, bromethalin, zinc phosphide, strychnine, pival, cholecalciferol, or other rodenticide compounds. The bait composition may also comprise grain, sugar, etc. and it may be solid, liquid, or a gel or paste composition. Solid bait may be in pellet or granular form. The compositions may also include insect growth regulators, contact insecticides, etc.

Other variants are also possible without departing from the scope of this invention.

What is claimed is:

1. A method for controlling vertebrate pests that inhabit burrows or tunnels in the ground, the method comprising the steps of:
(a) providing a bait station comprising a housing having a side wall with at least one opening therein;
(b) placing said bait station in the ground such that the opening in said housing is aligned with one of said tunnels;
(c) covering said bait station with soil; and
(d) placing a bait composition in said bait station, wherein said bait composition comprises an active ingredient for controlling said pests.

2. A method in accordance with claim 1, wherein said bait station further comprises a top surface with an opening therein, and a vertical tube extending between said opening in said top surface and the top of the ground, wherein bait composition can be introduced to said bait station through said vertical tube.

3. A method in accordance with claim 1, wherein said housing comprises opposing side walls which each have an opening therein; wherein each said opening is aligned with one of said tunnels.

4. A method in accordance with claim 1, wherein said bait composition includes an active ingredient selected from the group consisting of warfarin, chlorophacinone, diphacinone, bromadiolone, brodifacoum, difethialone, bromethalin, zinc phosphide, strychnine, pival, and cholecalciferol.

5. A bait station for presenting bait to a subterranean pest in a burrow or tunnel, the bait station comprising a housing with a side wall and a top surface; wherein said side wall includes at least one opening; wherein said top surface includes an aperture, and wherein a vertical tube communicates with said aperture for enabling bait composition to be introduced to said housing through said vertical tube.

6. A bait station in accordance with claim 5, wherein said housing includes opposing side walls, each of which has an opening therethrough.
